(19) United States
(12) Patent Application Publication
(10) Pub. No.: US 2018/0025655 A1
(43) Pub. Date: Jan. 25, 2018

(54) NEWBORN COMPUTER APPLICATIONS

(71) Applicant: Interactive applications, LLC, Charles City, IA (US)

(72) Inventor: Andrew Elthon, Charles City, IA (US)

(21) Appl. No.: 15/214,679

(22) Filed: Jul. 20, 2016

(51) Int. Cl. G09B 5/02; G09B 19/00

(52) U.S. Cl. CPC G09B 5/02; G09B 19/0076; G09B 19/0092

(57) ABSTRACT

An electronic version for how to care for an infant child on Smartphone/tablet devices. Students will access the application via the AppStore/Play Store on their device and will be provided login information from their administrator/teacher. At that point the application will be live and the student will begin performing the required tasks for the child through the device. This app will educate students how to perform the typical parenting duties such as changing diapers, feeding, rocking, reading stories, and playing with the baby. We will achieve this by having educational tutorials for each responsibility and examples of how to care for the child. The infant's status will be available for the student to view and will help to educate the student what he or she needs to do to care for the child. A website with login and tracking capabilities allowing the administrator to create and assign new accounts, as well as monitor and assesses student's progress.

### CROSS-REFERENCE TO RELATED APPLICATIONS

This application claims priority under 35 U.S.C. §119 to provisional application Ser. No. 62/194,646 filed Jul. 20, 2015, herein incorporated by reference in its entirety.

### FIELD OF THE INVENTION

The present invention relates to teaching about infant care. More particularly, though not exclusively, the present invention relates to a process, system, and application which allows for students to perform child care related tasks and for those tasks to be monitored, evaluated, and used for educating the student through an interactive application.

### BACKGROUND OF THE INVENTION

Schools have long sought effective methods of teaching students about childcare. The previous educational methods would involve demonstrations of typical parenting tasks, including changing diapers, feeding, rocking, reading stories, and playing with the baby, often involving dolls. Students also have previously participated in simulated care, where, for example, a student may be asked to care for an egg for a certain duration. Nearly all of these prior teaching techniques rely on the student to self-report. Any feedback was either based on the student's self-reported activity or on observation, but was not based on independently recorded data. Thus, there is a need in the art for a process, system, and application that enables educators to instruct and evaluate students based on independently recorded data.

Some systems use dolls to provide a more realistic experience. However, providing dolls for every student in a large class can get expensive. Moreover, the dolls can be damaged or soiled with repeated use. There is thus a need for a process, system and application which enables for realistic training without the additional costs of dolls.

### FEATURES OF THE INVENTION

It is desirable to provide a process, system and application for teaching child care which addresses the problems in the art.

A feature, object or advantage of the present invention is a process, system and application for teaching child care which includes a virtual baby that may be subjected to different activities which will be identified through various icons and baby sounds that will be played on a device.

Another feature, object or advantage of the present invention is a process, system and application for teaching child care which includes an application capable of setting a specific timeframe to notify the baby's activities to the end user or student who will then perform a specific act to care for the virtual baby.

A still further feature, object or advantage of the present invention is a process, system and application for teaching child care which includes various icons which can be selected to perform baby care acts.

Yet another feature, object or advantage of the present invention is a process, system and application for teaching child care which includes various icons which can be selected or sensed based on the position of the device.

Another feature, object or advantage of the present invention is a process, system and application for teaching child care which includes a network connection that enables the tracking of the baby's progress, including the baby's overall health and type of care provided by the user.

A still further feature, object or advantage of the present invention is a process, system and application for teaching child care which includes a website through which teachers, administrators, and students can monitor the level of care being provided to the virtual baby.

These features, objects or advantages will become apparent from the following description of the invention.

### SUMMARY OF THE INVENTION

The present invention relates to process, system and application for teaching child care which provides a first computer software program on a first non-transient computer storage medium, the first computer storage medium being operatively connected to a first computer device, with the first computer device including a transceiver to send and receive data, a sensor to detect motion of the computer device, and a user input device capable of detecting the touch of a user, wherein the first computer wherein the first computer software program requires a login, and wherein the first computer software program displays a virtual baby on the user input device, displaying a virtual baby on the first computer user input device, displaying on the first computer user input device a first activity requirement associated with the virtual baby, creating user activity data, the user activity data being associated with both the first activity requirement and the login, storing said user activity data on the first computer device, and providing a second computer software program on a second non-transient computer storage medium, the second computer storage medium being operatively connected to a second computer device, the second computer device including a transceiver to send and receive data, wherein the second computer receives data from the first computer, said data including user activity data which can be monitored for child care instruction.

The first computer device and the second computer device are preferably operatively connected through a network for at least a portion of the teaching period. The first non-transient computer storage medium is also preferably operatively connected to the first computer device through a network. The activity requirements may include feeding, playing, comforting, changing diapers, soothing with music, bath time, or sleeping.

### DESCRIPTION OF THE DRAWINGS

FIG. 1 is an example embodiment of a splash screen that will appear upon opening the application.

FIG. 2 is an example embodiment of a Tutorial screen for the application.

FIG. 3 is an example embodiment of a setup or login screen that may appear upon opening the application.

FIG. 4 is an alternative example embodiment of a setup or sign-up screen that may appear upon opening the application.

FIG. 5 is an alternative example embodiment of a setup screen that may be displayed to allow the user to select various features.

FIG. 6 is an example embodiment of a main screen of the application.

FIG. 7 is an example embodiment of a progress screen of the application.

FIG. 8 is an example embodiment of a settings screen of the application.

FIG. 9A-E represents example facial expressions that may be displayed on the main screen when infant is angry.

FIG. 10A-E represents example facial expressions that may be displayed on the main screen when infant is happy.

FIG. 11A-I represents example facial expressions that may be displayed on the main screen when infant is sad.

FIG. 12A-E represents example facial expressions that may be displayed on the main screen when infant is laughing.

FIG. 13A-e represents example facial expressions that may be displayed on the main screen when infant is spinning or being shaken.

FIG. 14A-C represents example facial expressions that may be displayed on the main screen when infant is uncomfortable or requires a diaper change.

FIG. 15A-E represents example facial expressions that may be displayed on the main screen when infant is hungry or feeding.

FIG. 16A-E represents example facial expressions that may be displayed on the main screen when infant is tired or sleeping.

FIG. 17 is a flow chart showing the general process of the present invention.

### DESCRIPTION OF THE PREFERRED EMBODIMENT

The present invention will now be described according to its preferred embodiment. The preferred embodiment is not the only embodiment and certain variations may be within the skill of one of ordinary skill in the art. These variations are meant to be encompassed by the following description and claims.

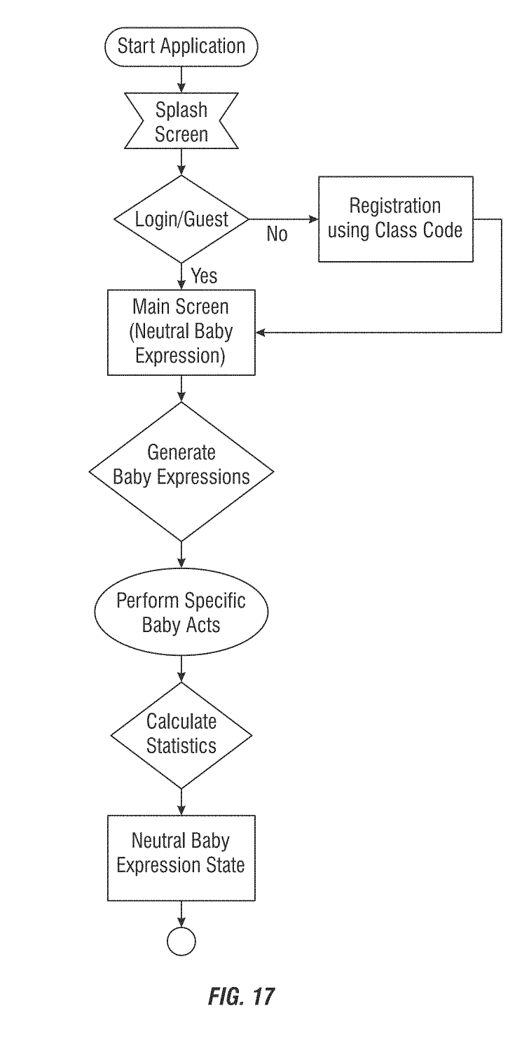

As shown in FIG. 17, a user will initially be provided with an application 10 which the user will then start. This application 10 is an electronic version for how to care for an infant child. The application 10 may be available and or accessed on iOS or Android Smartphone/tablet devices. Students will access the application 10 via the AppStore/Play Store on their device and will be provided login information from their administrator/teacher. At that point the application 10 will be live and the student will begin performing the required tasks for the child through the device. This app 10 will educate students how to perform the typical parenting duties such as changing diapers, feeding, rocking, soothing with music, bathing, and playing with the baby. We will achieve this by having educational tutorials for each responsibility and examples of how to care for the child. The infant's status will be available for the student to view and will help to educate the student what he or she needs to do to care for the child. A website with login and tracking capabilities allowing the administrator to create and assign new accounts, as well as, monitor and assesses student's progress. The main features of this application 10 are:
An application that consists of a virtual baby having different activities which will be identified through various icons and baby sounds that will be played on device.
A specific timeframe will be set to notify baby's activities to the end-user/student who will then perform a specific act to care for baby.
The baby care acts will be performed through icon selection or sensing the device's position.
A web site which will consist of login information for teachers/students, where user progress will be displays based on the level of care performed on baby.

Timely acts to be performed for virtual baby care on the device are:
Sleep/Comfort
Feed
Change Diaper
Sooth with Music
Bathing/Bath Time

The users of the application 10 will mainly belong to age group 12-19 years. The objective of the user is to take care of the infant and timely perform certain baby care acts that will be tracked to keep the infant in good health. Once the user installs the application 10 on their device, the age of the infant will be one day old, after which a day counter will track user's progress in maintaining the baby's care/health.

### First Launch

After the application 10 is launched, the user will have a short tutorial that will show the infant's care/health below the acceptable percentage and will ask the user to start taking care for the child through baby care acts to bring the infant in healthy status. A tutorial will help throughout this process for the first time to bring a baby at a normal caring/healthy status, after which the user will be responsible to take care of the child the way tutorial explained.

### Infant Expressions

The application 10 user will perform the baby care actions looking at the infant's expressions which will change in a range from 10% to 100%, where 10% would mean the worst condition of infant, where the expression such as crying loud/shaking around will be displayed and on 100% the infant will be shown in smiling/giggling. Each of the baby care actions will have their own percentage, which will be shown through statistics and color of icons that will fade in and out depending on the level achieved on that specific action. The rate/timeframe at which the health of an infant will decrease will be set on the basis of low to high range or at a random rate which can be set by users through application settings.

The expressions that an infant will concede are as below:
1. Normal expression, where the infant will be shown just normal healthy silent state.
2. Uncomfortable expression, where the infant would make body movements and make different sounds, which will require changing diapers.
3. Hunger expressions, a simple crying mode which may require playing/feeding.
4. Crying expression, where infant would cry out loud when more than one baby care actions are missed.
5. Happy expression, where the infant would smile/giggle/laugh when the infant is perfectly taken care of

Functional Hierarchy
Splash Screen
Tutorial Screen
Login Screen
Registration Screen
Home Screen
Baby Care Acts
   Sleep/Comfort
   Play
   Feed
   Change Diaper
   Sooth with Music
   Bath/Bath Time
Statistics Screen
Settings Screen

### Functional Hierarchy Details

As shown in FIG. 17, the following are the functional details of the application 10 which will be the showing the module break-up of all the core features available in this application 10.

### Splash Screen

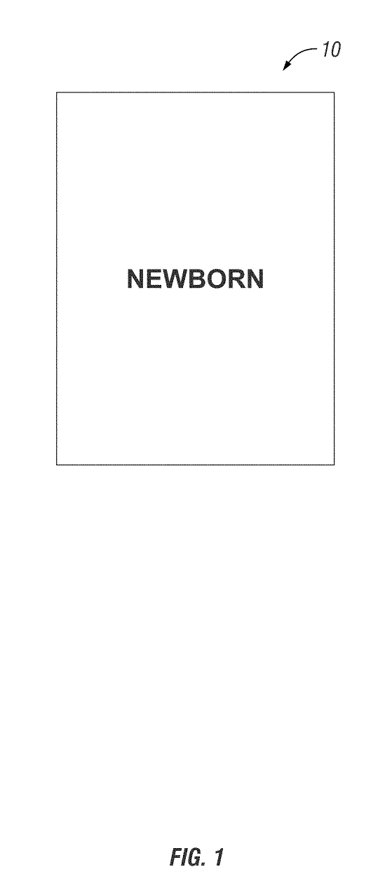

The application 10 will open up with a splash screen with a visual giving the user a feel of the new born progress app before they enter the next screen. An example embodiment of the splash screen 10 is shown in FIG. 1. The splash screen may display the title or name of the application.

### Tutorial Screen

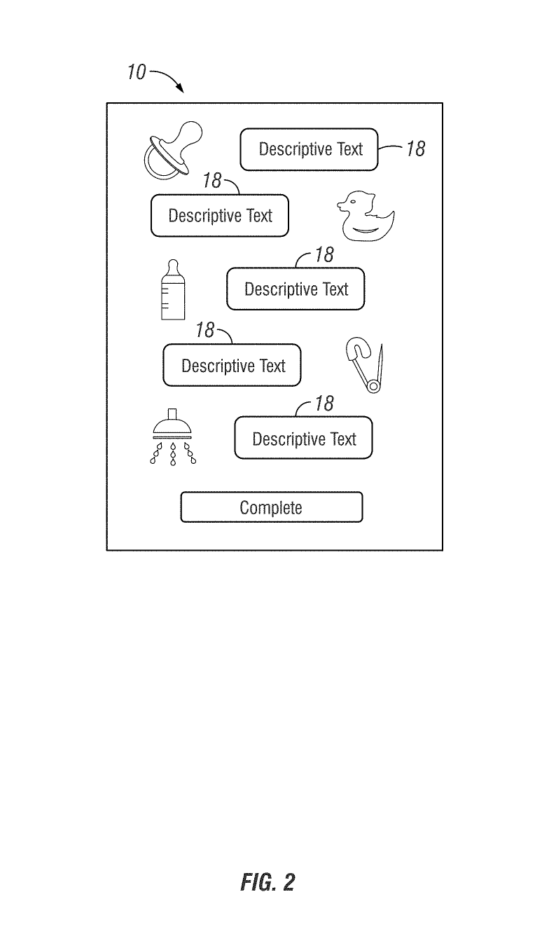

As shown in FIG. 2, the tutorial screen may showcase how to maintain a healthy infant and how to sync the user's progress to a main database or to an administrator's device. The tutorial screen may include user selectable buttons that link to or provide information for utilizing the application 10, as well as techniques and tips for caring for a new born or infant child.

### Login/Guest Screen

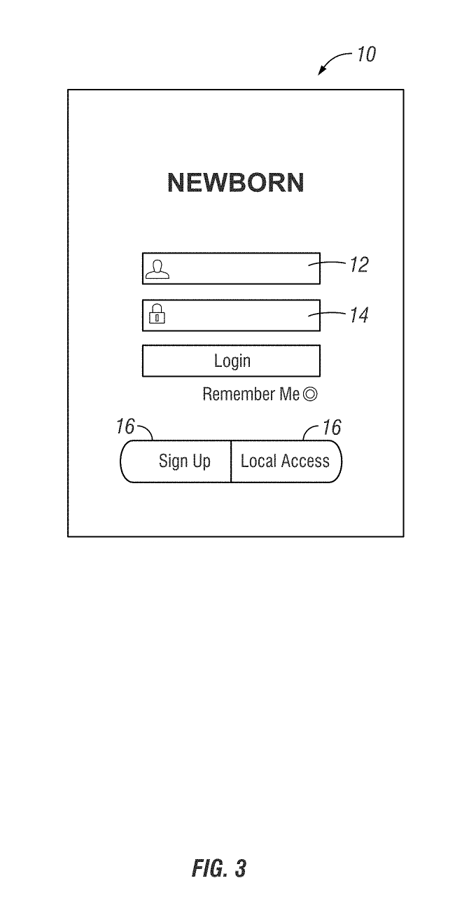

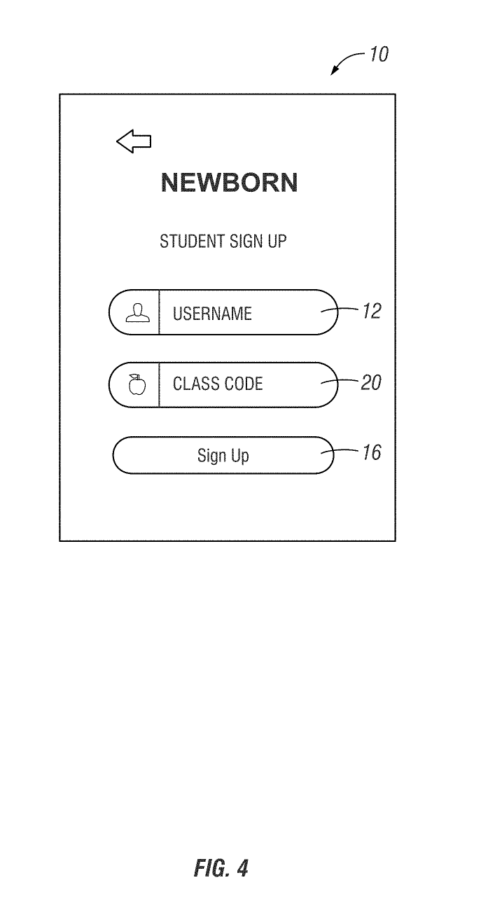

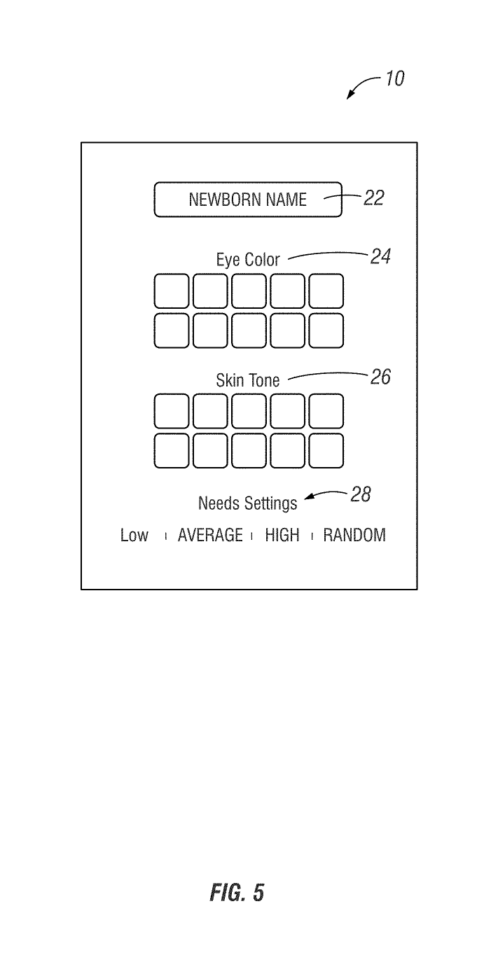

Once the application 10 is fully loaded, users will be directed to the next screen where they will be prompted to log-in. Example embodiments are shown in FIGS. 3 and 4. There will be two types of users; one of them can be a normal user of the application 10 who can use the application 10 without logging in, i.e. FIG. 3. The second kind will be Students, who will be given the option to log-in using their credentials along with the class code provide by a teacher, i.e. FIG. 4. The log-in screen may contain text blocks for the user to enter a user name 12, password, 14, and/or a class code 20. The user will need to enter a unique name of their choosing. This name will only have to be unique for the class, since a “class code” may be utilized by the system administrator to differentiate usernames in one location from those of another. For example, a user with the username of John123 in Iowa may be differentiated from a John123 in California.

When a system administrator, such as a teacher, creates an account, the may create a class lists with a custom name. Each time a class is created, it will have a unique code attached to it. This code is referred to the “class code”. This code can be shared with the users by the administrator. When the user enters the class code upon setup/sign-up, their account will be linked to the administrators account. Once the user has entered their information, the user may select a login or sign-up button 16 to load the users new born.

There may also be a behind the scenes device identifier. A unique behind-the-scenes code may be generated linking a device to the account. This will prevent cheating by users and allows each device to have only one Newborn at a time. If you lose the device, you may lose the Newborn.

### Main or Home Screen

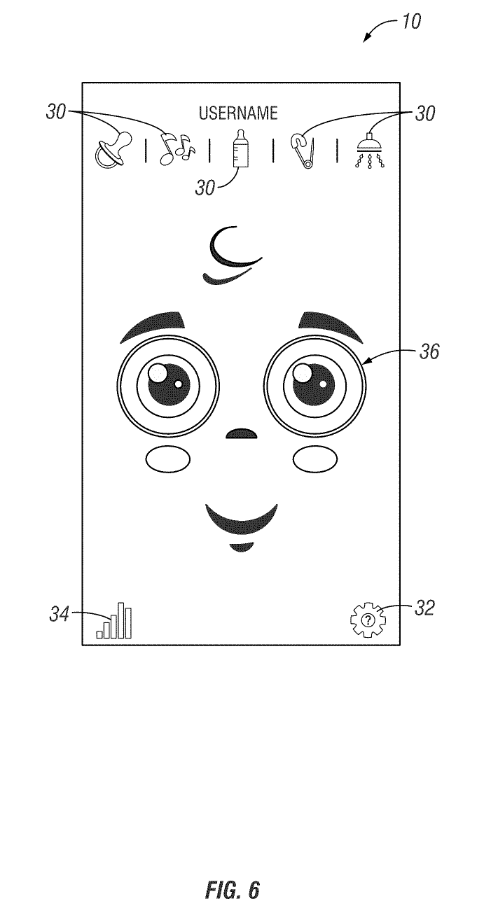

On the main screen, as shown in FIG. 6, a user can view an image/cartoon or other depiction of a baby 36, which will be able to generate and show different expressions 36 within different timeframes to help the user identify the moods of the baby, after which a user will be able to use the features 30 below to take the baby back to normal mode:
Sleep/Comfort 30
Play 30
Feed 30
Change Diaper 30
Sooth with Music 30
Bath/Bath Time 30

This screen 10 will also consist of a setting menu 32 and progress feature 34, using which a user will be able to set basic details regarding the baby and see the baby care progress, respectively.

### Perform Babycare Acts

The following are the acts that are to be performed after timely events of baby's expressions are fired, such as crying/sounds, movements etc.

### Sleep/Comfort

Sleep: The icon will be a pacifier 30. This action can be performed every twenty minutes. The icon will be white when the user can perform the action. They then perform the action by tapping the pacifier icon and rocking the tablet in their arms. After a set period of time the NEWBORN will laugh signaling the end of the action and the icon will go black. When the icon is black, it showcases to the user that the action cannot be performed again until the twenty minutes are up. Successfully completing this action will earn a point under the sleep progress bar.

### Bath

Bath: The icon will be a showerhead 30. This action can be performed every thirty minutes. The icon will be white when the user can perform the action. They then perform the action by tapping the showerhead icon and a bubble animation will occur. After a set period of time the NEWBORN will laugh signaling the end of the action and the icon will go black. When the icon is black, it showcases to the user that the action cannot be performed again until the thirty minutes are up. Successfully completing this action will earn a point under the bath progress bar.

### Feed

Feed: The icon will be a bottle 30. This action can be performed every twenty-four minutes. The icon will be white when the user can perform the action. They then perform the action by tapping the bottle icon and holding the tablet up in their arms with their finger touching the NEWBORN's mouth. After a set period of time the NEWBORN will laugh signaling the end of the action and the icon will go black. When the icon is black, it showcases to the user that the action cannot be performed again until the twenty-four minutes are up. Successfully completing this action will earn a point under the feeding progress bar.

### Change Diaper

Changing Diaper: The icon will be a clothespin 30. This action can be performed every twenty minutes. The icon will be white when the user can perform the action. They then perform the action by tapping the clothespin icon and placing the tablet on a flat surface. They then raise the bottom half of the device at an angle greater than 45 degrees. After a set period of time the NEWBORN will laugh signaling the end of the action and the icon will go black. When the icon is black, it showcases to the user that the action cannot be performed again until the twenty minutes are up. Successfully completing this action will earn a point under the changing diaper progress bar.

Sooth with Music

Sooth: The icon will be music notes 30. This action can be performed every twenty-five minutes. The icon will be white when the user can perform the action. They then perform the action by tapping the music note icon and the NEWBORN will giggle and sway to the music. After the song finishes, the NEWBORN will laugh signaling the end of the action and the icon will go black. When the icon is black, it showcases to the user that the action cannot be performed again until the twenty-five minutes are up. Successfully completing this action will earn a point under the soothing progress bar.

### Baby Care Acts and Expressions

Below is the table that shows certain expressions of infant, on the basis of which the user will be performing the respective baby care acts.

### Expression Baby Care Act

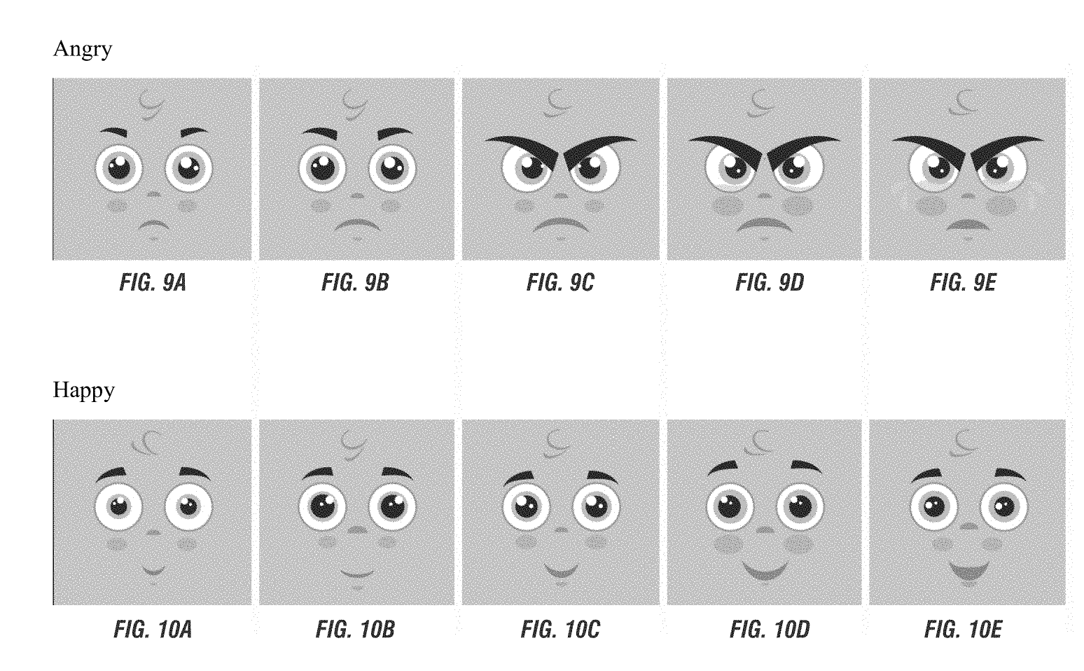

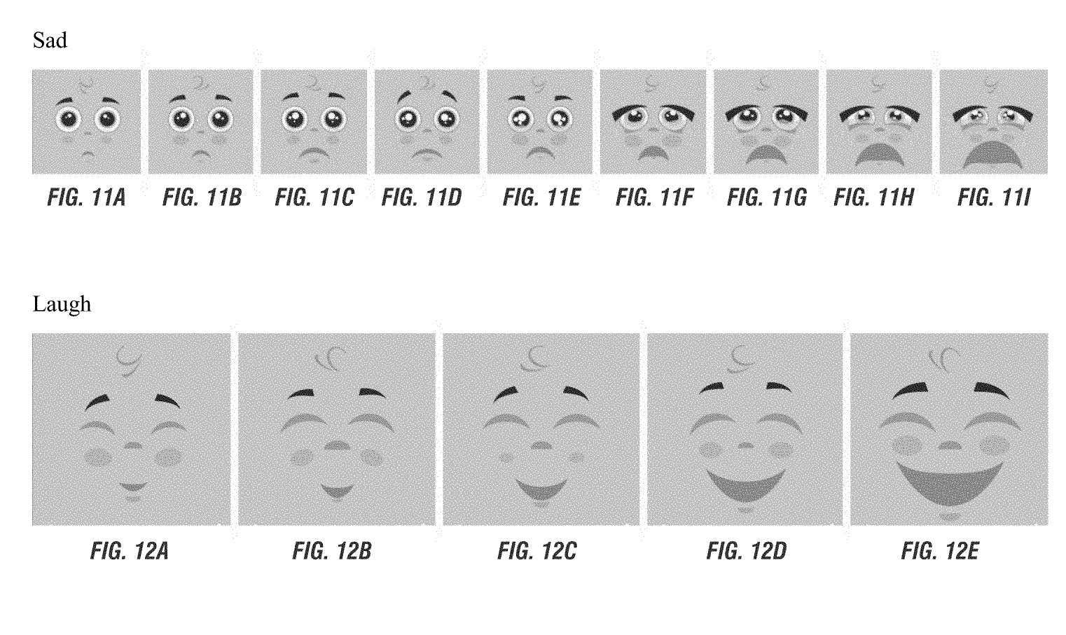

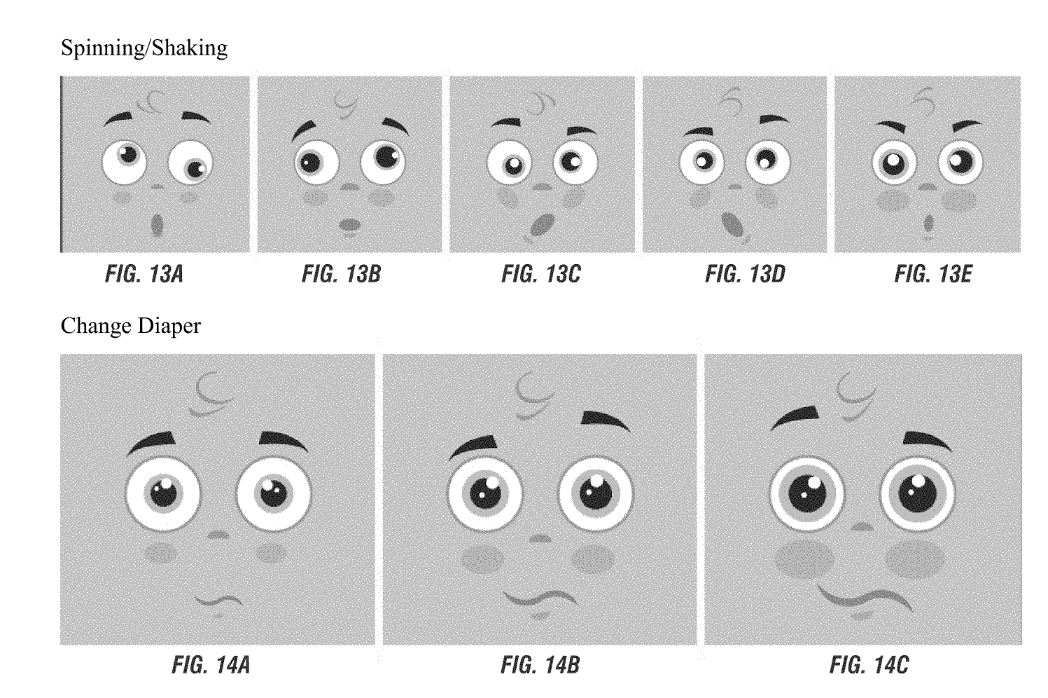

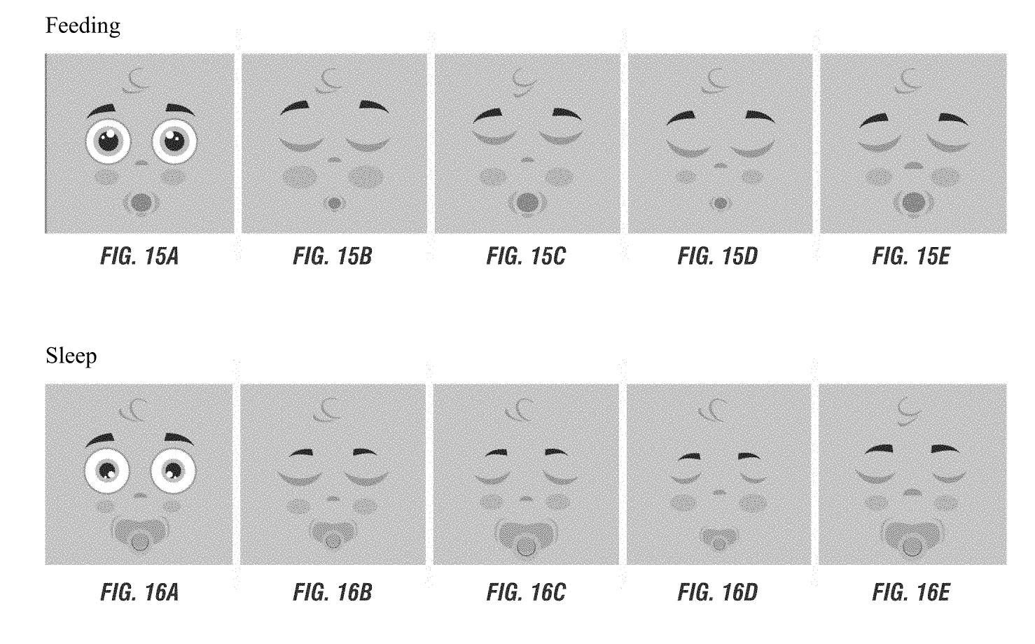

Happy, Normal, or Comfortable (FIG. 10A-E)
Laughing (FIG. 12A-E)
Angry (FIG. 9A-E)
Sad (FIG. 11A-I)
Sleeping (FIG. 16A-E)
Uncomfortable Change Diapers (FIG. 14A-C)
Spinning or Shaking (FIG. 13A-E)
Hungry or Feeding (FIG. 15A-E)
Sooth with Music
Bath Time
Crying Play/Check status for all acts

### Progress Screen

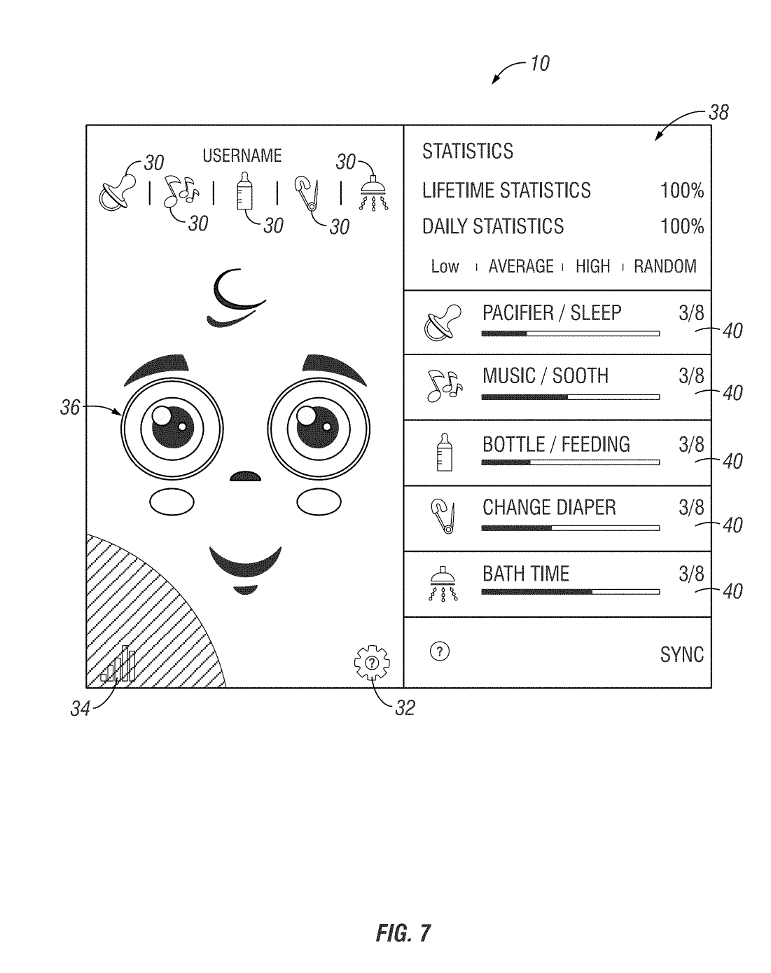

This screen, as shown in FIG. 7, will help users to see all the progress they are making in taking care of the infant. Users here can track the progress on simple graphs. This graph will show the percentage of expressions that ranges from worst to best on a scale of 10% to 100% with respect to the number of days the infant is initialized on the device.

The progress screen may include information some or all of the below:
Overall health of the baby, may be represented by a percentage or fraction.
How many days old the baby is.
Average daily breakdown of actions performed. May be represented by a graph, fraction, or percentage.
Daily health percentages.
The action icons will be displayed with fractions showing what still needs to be performed by the end user to maintain a health newborn.
Each action will be displayed with the name/icon, a bar graph showing progress, and the percentage or fraction showing how many actions remain.
Successfully completing an action will earn a point under the particular actions progress bar.
All actions have a cool down rate which is determined by the difficulty set by the end user. During this cool down period the end user will not be able to perform the action until the cool down period has ended.
All statistics are calculated and reported to the user on the statistics screen.

### NewBorn Milestones/Did You Know Facts

The following is a list of achievements that the users will be able to see and unlock as they interact with their newborn. Most achievements will be achieved by perform a certain action, a set number of times. Currently, the main areas that a teacher will want to see are simply if the user is maintaining a responsible health of their newborn. The achievements are just an added bonus of tracking the progress and allowing the user to interact within the application 10.

### Progress (Achievements)

Name your newborn.

Lay your newborn down to Sleep 5 Times in one day.

Lay your newborn down to Sleep 10 Times in one day.

Lay your newborn down to Sleep 15 Times in one day.

Lay the newborn down to Sleep 20 Times in one day.

Lay the newborn down to Sleep 25 Times in one day.

Play with your newborn 5 Times in one day.

Play with your newborn 10 Times in one day.

Play with your newborn 15 Times in one day.

Play with your newborn 20 Times in one day.

Play with your newborn 25 Times in one day.

Feed with your newborn 5 Times in one day.

Feed with your newborn 10 Times in one day.

Feed with your newborn 15 Times in one day.

Feed with your newborn 20 Times in one day.

Feed with your newborn 25 Times in one day.

Change your newborns diaper 5 Times in one day.

Change your newborns diaper 10 Times in one day.

Change your newborns diaper 15 Times in one day.

Change your newborns diaper 20 Times in one day.

Change your newborns diaper 25 Times in one day.

Read to your newborn 5 Times in one day.

Read to your newborn 10 Times in one day.

Read to your newborn 15 Times in one day.

Read to your newborn 20 Times in one day.

Read to your newborn 25 Times in one day.

Check on your newborn at least once an hour for 4 hours.

Check on your newborn at least once an hour for 6 hours.

Check on your newborn at least once an hour for 8 hours.

Check on your newborn at least once an hour for 10 hours.

Check on your newborn at least once an hour for 12 hours.

Check on your newborn at least once an hour for 14 hours.

Check on your newborn at least once an hour for 16 hours.

Check on your newborn at least once an hour for 18 hours.

Check on your newborn at least once an hour for 20 hours.

Check on your newborn at least once an hour for 22 hours.

Check on your newborn at least once an hour for 24 hours.

“DID YOU KNOW” Facts—that Appear Randomly and During Various Actions Performed while Application is in Use.

Wash your hands often with soap and water especially after changing a child's diapers, feeding, wiping their nose or mouth, and touching their toys, pacifier, or other objects.

Breastfeeding protects an infant from a wide array of infectious and noninfectious diseases.

Always place your baby on his or her back to sleep, even for naps. This is the safest sleep position for a healthy baby to reduce the risk of Sudden Infant Death Syndrome (SIDS).

Alcohol consumed during pregnancy can lead to Fetal Alcohol Syndrome (FAS). There is no safe amount of alcohol a woman can drink while pregnant.

In the first year, babies learn to focus their vision, reach out, explore, and learn about the things that are around them.

Cognitive, or brain development means the learning process of memory, language, thin king, and reasoning.

Children need a balance of nutrients from food for healthy brain growth and development.

Do not shake your baby-ever! Babies have very weak neck muscles that are not yet able to support their heads. If you shake your baby, you can damage his or her brain or even cause death.

Talk to your baby. He or she will find your voice calming.

Sing to your baby and play music. This will help your baby develop a love for music and will help his brain development.

The way parents cuddle, hold, and play with their baby will set the basis for how they will interact with them and others.

Play with your baby when he or she's alert and relaxed. Watch your baby closely for signs of being tired or fussy so that she can take a break from playing.

Never carry hot liquids or foods near your baby or while holding him.

Take care of yourself physically, mentally, and emotionally. Parenting can be hard work! It is easier to enjoy your new baby and be a positive, loving parent when you are feeling good yourself.

Under-nourished newborns grow more slowly and have less energy to learn and explore.

Answer when your baby makes sounds by repeating the sounds and adding words. This will help him learn to use language.

Newborns should not be given foods such as nuts, popcorn and raisins because they may cause choking.

Newborns grow and develop faster in the first year than any other year.

During the first six months of life, babies gradually gain information about the world around them.

At birth, a newborn brain weighs ⅔ to ¾ pounds (300-350 grams) and contains 100 billion neurons. The neurons controlling hearing and vision rapidly become myelinated.

When infants grow up in a regular, predictable world, they learn that they can trust their caregivers to meet their needs.

Teen pregnancy and childbearing can carry high health, emotional, social, and financial costs for both teen mothers and their children. Teen mothers want to do their best for their own health and that of their child, but some can become overwhelmed by life as a parent.

Although teen birth rates have been falling for the last two decades, more than 365,000 teens, ages 15-19, gave birth in 2010.

The ingredients in breast milk support healthy brain development in newborns. The fatty acids DHA (docosahexaenoic acid) and ARA (arachidonic acid) in breast milk promote rapid formation of myelin, the protective coating on the axons of neurons.

A baby nursing at the breast can focus on her mother's face, allowing eye contact and visual communication between the two.

Sleep is important to brain development. On average newborn babies sleep up to 16 hours per day, but only for a few hours at a time.

The American Academy of Pediatrics website has a wide variety of additional information on good health during infancy and childhood. www.aap.org/Prolonged stress in newborns can slow brain development and physical growth.

Prolonged stress in newborns can negatively affect the immune system.

Prolonged stress in newborns can cause long-term damage to the developing brain.

Consistent, loving support from caring adults can counteract much of the damage caused by stress in early childhood.

The most important experience for a newborn is you. Newborns love the time they spend with adults, and learn best through face-to-face interaction with other people.

Newborns and their parents begin the process of bonding shortly after birth.

Over time, newborns form specific attachment relationships with their parents.

Attachments formed early establish patterns for the way the newborn connects with people later in life.

Newborns form attachment relationships with many different people. Each attachment is different, and is specific to that individual. A newborns attachment to other adults will not replace his or her attachment to their parents.

Newborns do not necessarily need expensive toys. Enjoyment can come from everyday items around the house. Often a box can be more fun than an expensive toy.

### Settings

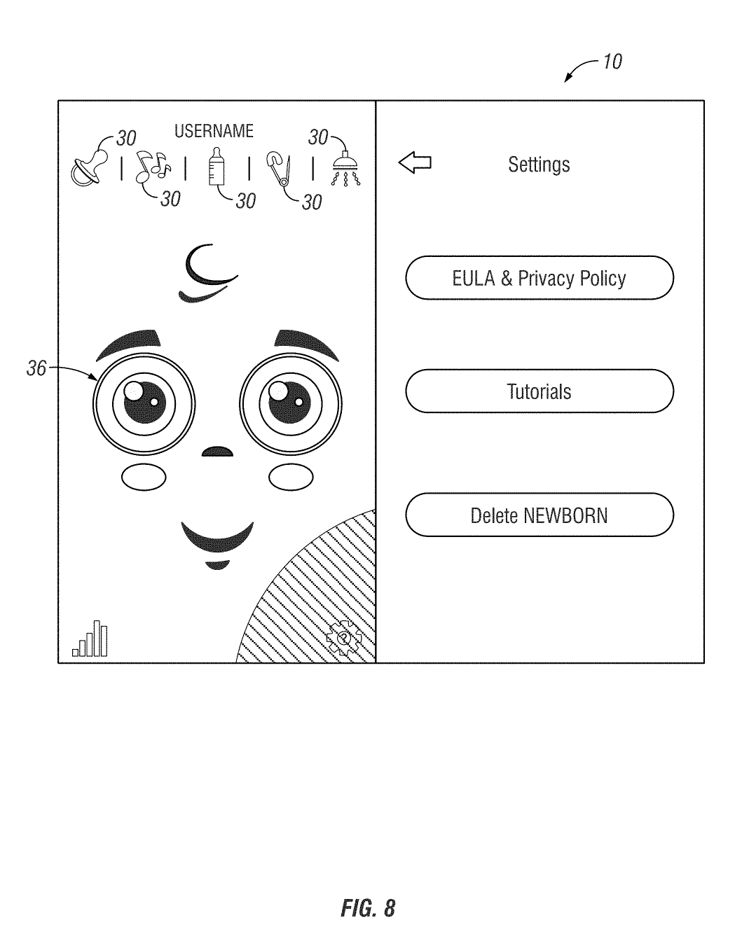

The setting screen 10, as shown in FIG. 8, will have the details, such as Infant's name, gender and skin color etc. The rate/timeframe at which the health of an infant will decrease will be set on the scale of low to high ranges or at a random rate which can be set by users through application settings.

### About

This popup screen will have the application/company information.

The application users can also be connected to a web site where teachers will register themselves and track student's progress on taking care of the infant. These students will be registered users of the mobile application 10 who register themselves on mobile devices by entering the class code provide to them by their teachers. This code will be generated for the teachers who register on the application website.

The flow of the website will be Home, Register, Login, Help, and About.

Home NewBorn web site for teacher to register and get their class code to share it with their students and track their progress through this website.

The present disclosure is not to be limited to the particular embodiments described herein. In particular, the present disclosure contemplates numerous variations in the type of ways in which embodiments of the disclosure may be applied to virtual baby care instruction. The foregoing description has been presented for purposes of illustration and description. It is not intended to be an exhaustive list or limit any of the disclosure to the precise forms disclosed. It is contemplated that other alternatives or exemplary aspects that are considered are included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives and the invention is to be limited only by the following claims.

What is claimed is:

1. A process for teaching child care, the process comprising:
a. providing a first computer software program on a first non-transient computer storage medium, the first computer storage medium being operatively connected to a first computer device, the first computer device including:
i. a transceiver to send and receive data,
ii. a sensor to detect motion of the computer device, and
iii. a user input device, the user input device capable of detecting the touch of a user,
b. displaying a virtual baby on the first computer user input device;
c. displaying on the first computer user input device one or more activity requirements associated with the virtual baby;
d. creating user activity data, the user activity data being associated with both the one or more activity requirements and a personal username specific to each individual user;
e. storing said user activity data on the first computer device; and
f. providing a second computer software program on a second non-transient computer storage medium, the second computer storage medium being operatively connected to a second computer device, the second computer device including a transceiver to send and receive data, wherein the second computer receives data from the first computer, said data including user activity data which can be monitored for child care instruction.

2. The process of claim 1, wherein the first computer device and the second computer device are operatively connected through a network.

3. The process of claim 1, wherein the first non-transient computer storage medium is operatively connected to the first computer device through a network.

4. The process of claim 1, wherein the first computer software program requires a login that includes the personal username that is specific to each individual user.

5. The process of claim 1, wherein the one or more activity requirements is selected from the group consisting of:
a. Feeding;
b. Playing;
c. Comforting;
d. Sleeping;
e. Soothing with Music;
f. Changing Diaper; or
g. Bathing.

6. The process of claim 5, wherein the virtual baby displayed on the first computer user input device comprises a facial expression to designate the activity requirement that should be performed by the user.

7. The process of claim 6, wherein the virtual baby displayed on the first computer user input device comprises a sad, whining, or crying expression to designate the changing diaper activity requirement.

8. The process of claim 6, wherein the virtual baby displayed on the first computer user input device comprises a sad, whining, or crying expression to designate the comfort activity requirement.

9. The process of claim 1, wherein the virtual baby displayed on the first computer user input device comprises a facial expression to suggest a current mood of the virtual baby.

10. The process of claim 1, wherein the first computer device is controlled and monitored by an individual user and the second computer device is operated by an administrator.

11. The process of claim 10, wherein the administrator can set parameters for the one or more activity requirements to be displayed on the first computer device.

12. The process of claim 11, wherein the administrator can set the frequency for when the one or more activity requirements may be displayed on the first computer device to low, high, or random.

13. The process of claim 1, further comprising displaying tips and/or techniques for caring for the virtual baby on the first computer device.

14. A process for teaching child care, the process comprising:
a. providing a plurality of user computer devices, each of the plurality of computer devices including a computer software program on a non-transient computer storage medium that is connected to the user computer device, each of the plurality of user computer devices further comprising:
i. a transceiver to send and receive data,
ii. a sensor to detect motion of the computer device, and
iii. a user input device, the user input device capable of detecting the touch of a user,
b. displaying a virtual baby on the plurality of user computer devices;
c. displaying on the plurality of user computer devices one or more activity requirements associated with the virtual baby;
d. creating user activity data, the user activity data being associated with both the one or more activity requirements and a personal username that is specific to each user; and
e. storing said user activity data on the plurality of user computer devices.

15. A process for teaching child care, the process comprising:
a. providing a first computer software program on a first non-transient computer storage medium, the first computer storage medium being operatively connected to a first computer device, the first computer device including:
i. a transceiver to send and receive data,
ii. a sensor to detect motion of the computer device, and
iii. a user input device, the user input device capable of detecting the touch of a user,
b. displaying a virtual baby on the first computer user input device;
c. displaying on the first computer user input device a first activity requirement associated with the virtual baby;
d. creating user activity data, the user activity data being associated with both the first activity requirement and a personal username specific to each user;
e. storing said user activity data on the first computer device; and
f. providing a second computer software program on a second non-transient computer storage medium, the second computer storage medium being operatively connected to a second computer device, the second computer device including a transceiver to send and receive data, wherein the second computer receives data from the first computer, said data including user activity data which can be monitored for child care instruction; and
wherein the first computer software program requires a login.
